(19) United States
(12) Patent Application Publication
(10) Pub. No.: US 2013/0132108 A1
(43) Pub. Date: May 23, 2013

(54) REAL-TIME CONTEXTUAL KPI-BASED AUTONOMOUS ALERTING AGENT

(71) Applicants: Nikita Victorovich Solilov, Barrington, IL (US); Piyush Raizada, Barrington, IL (US); Jianyong Zhang, Barrington, IL (US); Tushad Percy Driver, Barrington, IL (US); Vadim Y. Berezhanskiy, Barrington, IL (US); Evan James Bowling, Barrington, IL (US); Bhaumik Barot, Barrington, IL (US); Tianmin Shi, Barrington, IL (US)

(72) Inventors: Nikita Victorovich Solilov, Barrington, IL (US); Piyush Raizada, Barrington, IL (US); Jianyong Zhang, Barrington, IL (US); Tushad Percy Driver, Barrington, IL (US); Vadim Y. Berezhanskiy, Barrington, IL (US); Evan James Bowling, Barrington, IL (US); Bhaumik Barot, Barrington, IL (US); Tianmin Shi, Barrington, IL (US)

(21) Appl. No.: 13/303,739

(22) Filed: Nov. 23, 2011

(51) Int. Cl. G06Q 10/06; G06Q 50/22

(52) U.S. Cl. 705/2

(57) ABSTRACT

An example operation metrics collection and processing system is to mine a data set including patient and exam workflow data from information source(s) according to an operational metric for a workflow of interest. An example healthcare workflow performance monitoring system includes a contextual analysis engine to mine a data set to identify patterns based on current and historical healthcare data for a healthcare workflow and extract context information from the identified patterns and data mined information. The example system includes a statistical modeling engine to dynamically create contextual performance indicators based on the context and pattern information including a contextual ordering of events in the healthcare workflow. The example system includes a workflow decision engine to evaluate the contextual performance indicators based on a model and monitor measurements associated with the contextual performance indicators, the workflow decision engine to process feedback to update the context performance indicators.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### FIELD

The presently described technology generally relates to systems and methods to determine performance indicators in a workflow in a healthcare enterprise. More particularly, the presently described technology relates to computing performance metrics and alerting for a healthcare workflow.

### BACKGROUND

Most healthcare enterprises and institutions perform data gathering and reporting manually. Many computerized systems house data and statistics that are accumulated but have to be extracted manually and analyzed after the fact. These approaches suffer from “rear-view mirror syndrome”—by the time the data is collected, analyzed, and ready for review, the institutional makeup in terms of resources, patient distribution, and assets has changed. Regulatory pressures on healthcare continue to increase. Similarly, scrutiny over patient care increases.

Pioneering healthcare organizations such as Kaiser Permanente, challenged with improving productivity and care delivery quality, have begun to define Key Performance Indicators (KPI) or metrics to quantify, monitor and benchmark operational performance targets in areas where the organization is seeking transformation. By aligning departmental and facility KPIs to overall health system KPIs, everyone in the organization can work toward the goals established by the organization.

### BRIEF SUMMARY

Certain examples provide systems, apparatus, and methods for operation metrics collection and processing to mine a data set including patient and exam workflow data from information source(s) according to an operational metric for a workflow of interest.

Certain examples provide a computer-implemented method for generating contextual performance indicators for a healthcare workflow. The example method includes mining a data set to identify patterns based on current and historical healthcare data for a healthcare workflow. The example method includes extracting context information from the identified patterns and data mined information. The example method includes dynamically creating contextual performance indicators based on the context and pattern information. The example method includes evaluating the contextual performance indicators based on a model. The example method includes monitoring measurements associated with the contextual performance indicators. The example method includes processing feedback to update the context performance indicators.

Certain examples provide a tangible computer-readable storage medium having a set of instructions stored thereon which, when executed, instruct a processor to implement a method for generating operational metrics for a healthcare workflow. The example method includes mining a data set to identify patterns based on current and historical healthcare data for a healthcare workflow. The example method includes extracting context information from the identified patterns and data mined information. The example method includes dynamically creating contextual performance indicators based on the context and pattern information. The example method includes evaluating the contextual performance indicators based on a model. The example method includes monitoring measurements associated with the contextual performance indicators. The example method includes processing feedback to update the context performance indicators.

Certain examples provide a healthcare workflow performance monitoring system including a contextual analysis engine to mine a data set to identify patterns based on current and historical healthcare data for a healthcare workflow and extract context information from the identified patterns and data mined information. The example system includes a statistical modeling engine to dynamically create contextual performance indicators based on the context and pattern information including a contextual ordering of events in the healthcare workflow. The example system includes a workflow decision engine to evaluate the contextual performance indicators based on a model and monitor measurements associated with the contextual performance indicators, the workflow decision engine to process feedback to update the context performance indicators.

### BRIEF DESCRIPTION OF SEVERAL VIEWS OF THE DRAWINGS

FIG. 1 depicts an example healthcare information enterprise system to measure, output, and improve operational performance metrics.

FIG. 2 illustrates an example real-time analytics dashboard system.

FIG. 3 depicts a flow diagram for an example method for computation and output of operational metrics for patient and exam workflow.

FIG. 4 illustrates an example alerting and decision-making system.

FIG. 5 illustrates an example system for deployment of KPIs, notification, and feedback to hospital staff and/or system(s).

FIG. 6 illustrates an example flow diagram for a method for contextual KPI creation and monitoring.

FIG. 7 is a block diagram of an example processor system that may be used to implement the systems, apparatus and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Healthcare has recently seen an increase in a number of information systems deployed. Due to departmental differences, growth paths and adoption of systems have not always been aligned. Departments use departmental systems that are specific to their workflows. Increasingly, enterprise systems are being installed to address some cross-department challenges. Much expensive integration work is required to tie these systems together, and, typically, this integration is kept to a minimum to keep down costs and departments instead rely on human intervention to bridge any gaps.

For example, a hospital may have an enterprise scheduling system to schedule exams for all departments within the hospital. This is a benefit to the enterprise and to patients. However, the scheduling system may not be integrated with every departmental system due to a variety of reasons. Since most departments use their departmental information systems to manage orders and workflow, the department staff has to look at the scheduling system application to know what exams are scheduled to be performed and potentially recreate these exams in their departmental system for further processing.

Certain examples help streamline a patient scanning process in radiology by providing transparency to workflow occurring in disparate systems. Current patient scanning workflow in radiology is managed using paper requisitions printed from a radiology information system (RIS) or manually tracked on dry erase whiteboards. Given the disparate systems used to track patient prep, lab results, oral contrast, it is difficult for Technologists to be efficient, as they need to poll the different systems to check status of patient. Further this information is not easily communicated as it is tracked manually. So any other individual would need to look up this information again or check information via a phone call.

The system provides an electronic interface to display information corresponding to any event in the patient scanning and image interpretation workflow. With visibility to completion on workflow steps in different systems, manually track completion of workflow in the system, visual timer to countdown activity or tasks in radiology.

Certain examples provide electronic systems and methods to capture additional elements that result in delays. Certain example systems and methods capture information electronically including: one or more delay reasons for an exam and/or additional attribute(s) that describe an exam (e.g., an exam priority flag).

Workflow definition can vary from institution to institution. Some institutions track nursing preparation time, radiologist in room time, etc. These states (events) can be dynamically added to a decision support system based on a customer's needs, wants, and/or preferences to enable measurement of key performance indicator(s) (KPI) and display of information associated with KPIs.

Certain examples provide a plurality of workflow state definitions. Certain examples provide an ability to store a number of occurrences of each workflow state and to track workflow steps. Certain examples provide an ability to modify a sequence of workflow to be specific to a particular site workflow. Certain examples provide an ability to cross reference patient visit events with exam events.

Current dashboard solutions are typically based on data in a RIS or picture archiving and communication system (PACS). Certain examples provide an ability to aggregate data from a plurality of sources including RIS, PACS, modality, virtual radiography (VR), scheduling, lab, pharmacy systems, etc. A flexible workflow definition enables example systems and methods to be customized to customer workflow configuration with relative ease.

Additionally, rather than attempting to provide integration between disparate systems, certain examples mimic the rationale used by staff (e.g., configurable per the workflow of a healthcare site) to identify exams in two or more disconnected systems that are the same and/or connected in some way. This allows the site to continue to keep the systems separate but adds value by matching and presenting these exams as a single/same exam, thereby reducing a need for a staff to link exams manually in either system.

Certain examples provide a rules based engine that can be configured to match exams it receives from two or more systems based on user selected criteria to evaluate if these different exams are actually the same exam that is to be performed at the facility. Attributes that can be configured include patient demographics (e.g., name, age, sex, other identifier(s), etc.), visit attributes (e.g., account number, etc.), date of examination, procedure to be performed, etc.

Once two or more exams received from different systems are identified as being the same, single exam, one or more exams are deactivated from the set of linked exams such that only one of the exam entries is presented to an end user. Rather than merging the two exams, a system can be configured to display an exam received from the ordering system and de-activate the exam received from a scheduling system.

For example, when a scheduling system at a hospital is not interfaced with an order entry/management system. When a patient calls to schedule an exam, a record is created in the scheduling system which is then forwarded to a decision support system. Upon arrival of the patient at the hospital, an order is created in the order entry system (e.g., a RIS) to manage an exam-related departmental workflow. This information is also received by the decision support system as a separate exam.

Without an ability to identify related exams and determine which of the related exams should be presented, a decision support dashboard would display two exam entries for what is in reality a single exam. With this capability, the decision support system disables the scheduled exam upon receipt of an order for that patient, preventing both exams from appearing on the dashboard as pending exams. Only the ordered exam is retained. Before the ordered exam information is received, the decision support system displays the scheduled exam.

Thus, a staff user is not required to manually intervene to remove exam entries from a scheduling and/or decision support application. Rather, the exam entry does not progress in a workflow as its ordered counterpart. Behavior of linked or related exams can be customized based on a hospital's workflow without requiring code changes, for example.

Certain examples provide systems and methods to determine operational metrics or key performance indicators (KPIs) such as patient wait time. Certain examples facilitate a more accurate calculation of patient wait time and/or other metric/indicator with a multiple number of patient workflow events to accommodate variation of workflow.

Hospital administrators should be able to quantify an amount of time a patient is waiting during a radiology workflow, for example, where the patient is prepared and transferred to obtain radiology examination by scanners such as magnetic resonance (MR) and/or computed tomography (CT) imaging systems. A more accurate quantification of patient wait time helps to improve patient care and optimize or improve radiology and/or other healthcare department/enterprise operation.

Certain examples help provide an understanding of the real-time operational effectiveness of an enterprise and help enable an operator to address deficiencies. Certain examples thus provide an ability to collect, analyze and review operational data from a healthcare enterprise in real time or substantially in real time given inherent processing, storage, and/or transmission delay. The data is provided in a digestible manner adjusted for factors that may artificially affect the value of the operational data (e.g., patient wait time) so that an appropriate responsive action may be taken.

KPIs are used by hospitals and other healthcare enterprises to measure operational performance and evaluate a patient experience. KPIs can help healthcare institutions, clinicians, and staff provide better patient care, improve department and enterprise efficiencies, and reduce the overall cost of delivery. Compiling information into KPIs can be time consuming and involve administrators and/or clinical analysts generating individual reports on disparate information systems and manually aggregating this data into meaningful information.

KPIs represent performance metrics that can be standard for an industry or business but also can include metrics that are specific to an institution or location. These metrics are used and presented to users to measure and demonstrate performance of departments, systems, and/or individuals. KPIs include, but are not limited to, patient wait times (PWT), turn around time (TAT) on a report or dictation, stroke report turn around time (S-RTAT), or overall film usage in a radiology department. For dictation, a time can be a measure of time from completed to dictated, time from dictated to transcribed, and/or time from transcribed to signed, for example.

In certain examples, data is aggregated from disparate information systems within a hospital or department environment. A KPI can be created from the aggregated data and presented to a user on a Web-enabled device or other information portal/interface. In addition, alerts and/or early warnings can be provided based on the data so that personnel can take action before patient experience issues worsen.

For example, KPIs can be highlighted and associated with actions in response to various conditions, such as, but not limited to, long patient wait times, a modality that is underutilized, a report for stroke, a performance metric that is not meeting hospital guidelines, or a referring physician that is continuously requesting films when exams are available electronically through a hospital portal. Performance indicators addressing specific areas of performance can be acted upon in real time (or substantially real time accounting for processing, storage/retrieval, and/or transmission delay), for example.

In certain examples, data is collected and analyzed to be presented in a graphical dashboard including visual indicators representing KPIs, underlying data, and/or associated functions for a user. Information can be provided to help enable a user to become proactive rather than reactive. Additionally, information can be processed to provide more accurate indicators accounting for factors and delays beyond the control of the patient, the clinician, and/or the clinical enterprise. In some examples, “inherent” delays can be highlighted as separate actionable items apart from an associated operational metric, such as patient wait time.

Certain examples provide configurable KPI (e.g., operational metric) computations in a work flow of a healthcare enterprise. The computations allow KPI consumers to select a set of relevant qualifiers to determine a scope of a data countable in the operational metrics. An algorithm supports the KPI computations in complex work flow scenarios including various work flow exceptions and repetitions in an ascending or descending work flow statuses change order (such as, exam or patient visit cancellations, re-scheduling, etc.), as well as in scenarios of multi-day and multi-order patient visits, for example.

Multiple exams during a single patient visit can be linked based on visit identifier, date, and/or modality, for example. The patient is not counted multiple times for wait time calculation purposes. Additionally, all associated exams are not marked as dictated when an event associated with dictation of one of the exams is received.

Once the above computations are completed, visits and exams are grouped according to one or more time threshold(s) as specified by one or more users in a hospital or other monitored healthcare enterprise. For example, an emergency department in a hospital wants to divide the patient wait times during visits into 0-15 minute, 15-30 minute, and over 30 minute wait time groups.

Once data can be grouped in terms of absolute numbers or percentages, it can be presented to a user. The data can be presented in the form of various graphical charts such as traffic lights, bar charts, and/or other graphical and/or alphanumeric indicators based on threshold(s), etc.

Thus, certain examples help facilitate operational data-driven decision-making and process improvements. To help improve operational productivity, tools are provided to measure and display a real-time (or substantially real-time) view of day-to-day operations. In order to better manage an organization's long-term strategy, administrators are provided with simpler-to-use data analysis tools to identify areas for improvement and monitor the impact of change.

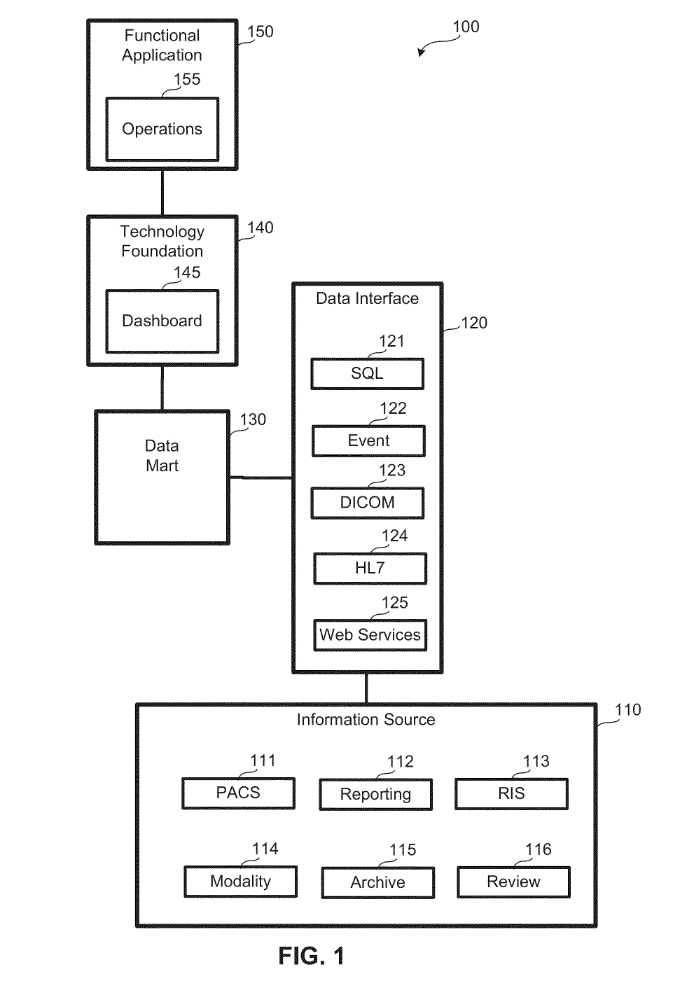

FIG. 1 depicts an example healthcare information enterprise system 100 to measure, output, and improve operational performance metrics. The system 100 includes a plurality of information sources, a dashboard, and operational functional applications. More specifically, the example system 100 shown in FIG. 1 includes a plurality of information sources 110 including, for example, a picture archiving and communication system (PACS) 111, a precision reporting subsystem 112, a radiology information system (RIS) 113 (including data management, scheduling, etc.), a modality 114, an archive 115, a modality 116, and a quality review subsystem 116 (e.g., PeerVue™).

The plurality of information sources 110 provide data to a data interface 120. The data interface 120 can include a plurality of data interfaces for communicating, formatting, and/or otherwise providing data from the information sources 110 to a data mart 130. For example, the data interface 120 can include one or more of an SQL data interface 121, an event-based data interface 122, a Digital Imaging and Communications in Medicine (DICOM) data interface 123, a Health Level Seven (HL7) data interface 124, and a web services data interface 125.

The data mart 130 receives and stores data from the information source(s) 110 via the interface 120. The data can be stored in a relational database and/or according to another organization, for example. The data mart 130 provides data to a technology foundation 140 including a dashboard 145. The technology foundation 140 can interact with one or more functional applications 150 based on data from the data mart 130 and analytics from the dashboard 145, for example. Functional applications can include operations applications 155, for example.

As will be discussed further below, the dashboard 145 includes a central workflow view and information regarding KPIs and associated measurements and alerts, for example. The operations applications 155 include information and actions related to equipment utilization, wait time, report read time, number of cases read, etc.

KPIs reflect the strategic objectives of the organization. Examples in Radiology include but are not limited to reduction in patient wait times, improving exam throughput, reducing dictation and report turn-around times, and increasing equipment utilization rate. KPIs are used to assess the present state of the organization, department or the individual and to provide actionable information with a clear course of action. They assist a healthcare organization to measure progress towards the goals and objectives established for success. Departmental managers and other front-line staff, however, find it difficult to pro-actively manage to these KPIs in real-time. This is at least partly because the data to build KPIs resides in disparate information sources and should be correlated to compute KPI performance.

A KPI can accommodate, but is not limited to, the following workflow scenarios:

1. Patient wait times until an exam is started.

2. Turn-around times between any hospital workflow states.

3. Add or remove multiple exam/patient states from KPI computations. For example, some hospitals wish to add multiple lab states in a patient workflow, and KPI computations can account for these states in the calculations.

4. Canceled visits and exams should automatically be excluded from computations.

5. Multiple exams in single patient visit during single day should be distinguished from single patient wait time versus single patient same exam during multiple days.

6. Wait time deductions should be applied where drugs are administered and drugs take time to come into affect.

7. Off business hours should be excluded from turn around and/or wait times of different events.

8. Exam should be allowed to roll back into any previous state and should be excluded or included in KPI calculations accordingly.

9. A user should have options to configure KPI according to hospital needs/wants/preferences, and KPI should perform calculations according to user configurations.

10. Multiple exams should be linked to single exams if the exams are from a single visit, same modality, same patient, and same day, for example.

Using KPI computation(s) and associated support, a hospital and/or other healthcare administrator can obtain more accurate information of patient wait time and/or turn-around time between different workflow states in order to optimize or improve operation to provide better patient care.

Even if a patient workflow involves an alternate workflow, the application can obtain multiple workflow events to process a more accurate patient wait time. Calculation of patient wait time or turn-around time between different workflow states can be configured and adjusted for different workflow and procedures.

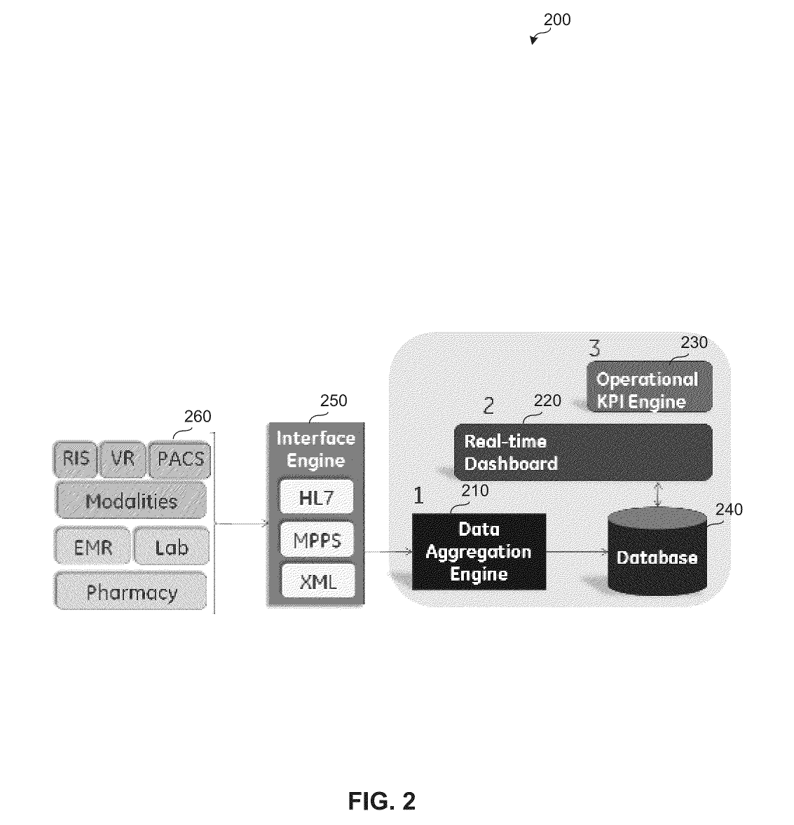

FIG. 2 illustrates an example real-time analytics dashboard system 200. The real-time analytics dashboard system 200 is designed to provide radiology and/or other healthcare departments with transparency to operational performance around workflow spanning from schedule (order) to report distribution.

The dashboard system 200 includes a data aggregation engine 210 that correlates events from disparate sources 260 via an interface engine 250. The system 200 also includes a real-time dashboard 220, such as a real-time dashboard web application accessible via a browser across a healthcare enterprise. The system 200 includes an operational KPI engine 230 to pro-actively manage imaging and/or other healthcare operations. Aggregated data can be stored in a database 240 for use by the real-time dashboard 220, for example.

The real-time dashboard system 200 is powered by the data aggregation engine 210, which correlates in real-time (or substantially in real time accounting for system delays) workflow events from PACS, RIS, and other information sources, so users can view status of patient within and outside of radiology and/or other healthcare department(s).

The data aggregation engine 210 has pre-built exam and patient events, and supports an ability to add custom events to map to site workflow. The engine 210 provides a user interface in the form of an inquiry view, for example, to query for audit event(s). The inquiry view supports queries using the following criteria within a specified time range: patient, exam, staff, event type(s), etc. The inquiry view can be used to look up audit information on an exam and visit events within a certain time range (e.g., six weeks). The inquiry view can be used to check a current workflow status of an exam. The inquiry view can be used to verify staff patient interaction audit compliance information by cross-referencing patient and staff information.

The interface engine 250 (e.g., a clinical content gateway (CCG) interface engine) is used to interface with a variety of information sources 260 (e.g., RIS, PACS, VR, modalities, electronic medical record (EMR), lab, pharmacy, etc.) and the data aggregation engine 210. The interface engine 250 can interface based on HL7, DICOM, eXtensible Markup Language (XML), modality performed procedure step (MPPS), and/or other message/data format, for example.

The real-time dashboard 220 supports a variety of capabilities (e.g., in a web-based format). The dashboard 220 can organize KPI by facility and allow a user to drill-down from an enterprise to an individual facility (e.g., a hospital). The dashboard 220 can display multiple KPI simultaneously (or substantially simultaneously), for example. The dashboard 220 provides an automated “slide show” to display a sequence of open KPI. The dashboard 220 can be used to save open KPI, generate report(s), export data to a spreadsheet, etc.

The operational KPI engine 230 provides an ability to display visual alerts indicating bottleneck(s) and pending task(s). The KPI engine 230 computes process metrics using data from disparate sources (e.g., RIS, modality, PACS, VR, etc.). The KPI engine 230 can accommodate and process multiple occurrences of an event and access detail data under an aggregate KPI metric, for example. The engine 230 can specify a user-defined filter and group by options. The engine 230 can accept customized KPI thresholds, time depth, etc., and can be used to build custom KPI to reflect a site workflow, for example.

KPI generated can include a turnaround time KPI, which calculates a time taken from one or more initial workflow states to complete one or more final states, for example. The KPI can be presented as an average value on a gauge or display counts grouped into turnaround time categories on a stacked bar chart, for example.

A wait time KPI calculates an elapsed time from one or more initial workflow states to a current time until a set of final workflow states have not been completed, for example. This KPI is visualized in a traffic light displaying counts of exams grouped by time thresholds, for example.

A comparison or count KPI computes counts of exams in one state versus another state for a given time period. Alternatively, counts of exams in a single state can be computed (e.g., a number of cancelled exams). This KPI is visualized in the form of a bar chart, for example.

The dashboard system 200 can provide graphical reports to visualize patterns and quickly identify short-term trends, for example. Reports are defined by, for example, process turnaround times, asset utilization, throughput, volume/mix, and/or delay reasons, etc.

The dashboard system 200 can also provide exception outlier score cards, such as a tabular list grouped by facility for a number of exams exceeding turnaround time threshold(s).

The dashboard system 200 can provide a unified list of pending emergency department (ED), outpatient, and/or inpatient exams in a particular modality (e.g., department) with an ability to: 1) display status of workflow events from different systems, 2) indicate pending multi-modality exams for a patient, 3) track time for a certain activity related to an exam via countdown timer, and/or 4) electronically record Delay Reasons, a Timestamp for the occurrence of a workflow event, for example.

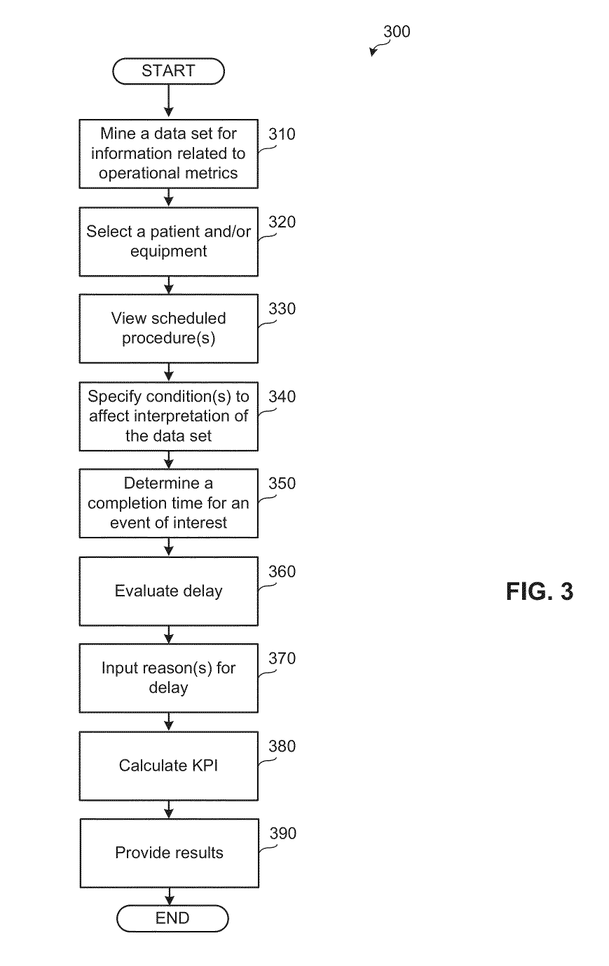

FIG. 3 depicts an example flow diagram representative of process(es) that can be implemented using, for example, computer readable instructions that can be used to facilitate collection of data, calculation of KPIs, and presentation for review of the KPIs. The example process(es) of FIG. 3 can be performed using a processor, a controller and/or any other suitable processing device. For example, the example processes of FIG. 3 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIG. 3 can be implemented using coded instructions (e.g., computer readable instructions) stored on a non-transitory computer readable medium such as a flash memory, a read-only memory (ROM), a random-access memory (RAM), a CD, a DVD, a Blu-ray, a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIG. 3 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIG. 3 can be implemented manually or as any combination(s) of any of the foregoing techniques, for example, any combination of firmware, software, discrete logic and/or hardware. Further, although the example process(es) of FIG. 3 are described with reference to the flow diagram of FIG. 3, other methods of implementing the processes of FIG. 3 may be employed. For example, the order of execution of the blocks can be changed, and/or some of the blocks described may be changed, eliminated, sub-divided, or combined. Additionally, any or all of the example process(es) of FIG. 3 can be performed sequentially and/or in parallel by, for example, separate processing threads, processors, devices, discrete logic, circuits, etc.

FIG. 3 depicts a flow diagram for an example method 300 for computation and output of operational metrics for patient and exam workflow. At block 310, an available data set is mined for information relevant to one or more operational metrics. For example, an operational data set obtained from multiple information sources, such as image modality and medical record archive data sources, are mined at both an exam and a patient visit level within a specified time range based on initial and final states of patient visit and exam workflow. This data set includes date and time stamps for events of interest in a hospital workflow along with exam and patient attributes specified by standards/protocols, such as HL7 and/or DICOM standards.

At block 320, one or more patient(s) and/or equipment of interest are selected for evaluation and review. For example, one or more patients in one or more hospital departments and one or more pieces of imaging equipment (e.g., CT scanners) are selected for review and KPI generation. At block 330, scheduled procedures are displayed for review.

At block 340, a user can specify one or more conditions to affect interpretation of the data in the data set. For example, the user can specify whether any or all states relevant to a workflow of interest have or have not been reached. For example, the user also has an ability to pass relevant filter(s) that are specific to a hospital workflow. A resulting data set is built dynamically based on the user conditions.

At block 350, a completion time for an event of interest is determined. At block 360, a delay associated with the event of interest is evaluated. At block 370, one or more reasons for delay can be provided. For example, equipment setup time, patient preparation time, conflicted usage time, etc., can be provided as one or more reasons for a delay.

At block 380, one more KPIs can be calculated based on the available information. At block 390, results are provided (e.g., displayed, stored, routed to another system/application, etc.) to a user.

Thus, certain examples provide systems and methods to assist in providing situational awareness to steps and delays related to completion of patient scanning workflow. Certain examples provide a current status of patient in a scanning process, electronically recorded delay reasons, and a KPI computation engine that aggregates and provides data for display via a user interface. Information can be presented in a tabular list and/or a calendar view, for example. Situational awareness can include patient preparation (e.g., oral contrast administered/dispense time), lab results and/or order result time, nursing preparation start/complete time, exam order time, exam schedule time, patient arrival time, etc.

Given the dynamic nature of workflow in healthcare institutions, time stamps can be tracked for custom states. Certain examples provide an extensible way to track workflow events, with minimal effort. An example operational metrics engine also tracks the current state of an exam, for example. Activities shown on a dashboard (whiteboard) result in tracking time stamp(s), communicating information, and/or automatically changing state based on one or more rules, for example. Certain examples allow custom addition of states and associated color and/or icon presentation to match customer workflow, for example.

Most organizations lack electronic data for delays in workflow. In certain examples, a real-time dashboard allows tracking of multiple delay reasons for a given exam via reason codes. Reason codes are defined in a hierarchical structure with a generic set that applies across all modalities, extended by modality specific reason codes, for example. This allows presenting relevant delay codes for a given modality

Certain examples provide an ability to support multiple occurrences of a single workflow step (e.g., how many times a user entered an application/workflow and did something, did nothing, etc.). Certain examples provide an ability to select a minimum, a maximum, and/or a count of multiple times that a single workflow step has occurred. Certain examples provide a customizable workflow definition and/or an ability to correlate multiple modality exams. Certain examples provide an ability to track a current state of exam across multiple systems.

Certain examples provide an extensible workflow definition wherein a generic event can be defined which represents any state. An example engine dynamically adapts to needs of a customer without planning in advance for each possible workflow of the user. For example, if a user's workflow is defined today to include A, B, C, and D, the definition can be dynamically expanded to include E, F, and G and be tracked, measured, and accommodated for performance without creating rows and columns in a workflow state database for each workflow eventuality in advance.

This information can be stored in a row of a workflow state table, for example. Data can be transposed dynamically from a dashboard based on one or more rules, for example. For example, a KPI rules engine can take a time stamp, such as an ordered time stamp, a scheduled time stamp, an arrived time stamp, a completed time stamp, a verified time stamp, etc., and each category of time stamp that as an event type associated with a number of occurrences. A user can select a minimum or maximum of an event, track multiple occurrences of an event, count a number of events by patient and/or exam, track patient visit level event(s), etc.

Frequently, multiple tests are ordered for a single patient, and these tests are viewed on exam lists filtered for a given modality without any indicator of the other modality exams. This leads to “waste” in patient transport as, quite often, the patient is returned to the original location rather than being handed off from one modality to another. A real-time dashboard provides a way to correlate multiple modality exams at a patient level and display one or more corresponding indicator(s), for example. For example, multiple modalities can be cross-referenced to show that a patient has an x-ray, CT, and ultrasound all scheduled to happen in one day.

In certain example, not only are time stamps captured and metrics presented, but accompanying delay reasons, etc., are captured and accounted for as well. In addition to system-generated timestamps, a user can interact and add a delay reason in conjunction with the timestamp, for example.

In certain examples, when computing KPIs, a modality filter is excluded upon data selection. Data is grouped by visit and/or by patient identifier, selecting aggregation criteria to correlate multi-modality exams, for example. Data can be dynamically transposed, for example. The example analysis returns only exams for the filtered modality with multi modality indicators.

Certain examples provide systems and methods to identify, prioritize, and/or synchronize related exams and/or other records. In certain examples, messages can be received for the same domain object (e.g., an exam) from different sources. Based on customer created rules, the objects (e.g., exams) are matched such that it is confidently determine that two or more exam records belonging to different systems actually represent the same exam, for example.

Based on the information included in the exam records, one of the exam records is selected as the most eligible/applicable record, for example. By selecting a record, a corresponding source system is selected whose record is to be used, for example. In some examples, multiple records can be selected and used. Other, non-selected matching records are hidden from display. These hidden exams are linked to the displayed exam implicitly based on rules. In certain examples, there is no explicit linking via references, etc.

Matching exams in a set progress in lock-step through the workflow, for example. When a status update is received for one exam in the set, all exams are updated to the same status together. In certain examples, this behavior applies only to status updates. In certain examples, due to updates to an individual exam record from its source system (other than a status update), if an updated exam no longer matches with the linked set of exams, it is automatically unlinked from the other exams and moves (progresses/regresses) in the workflow independently. In certain examples, due to updates to an individual exam record from its source system, a hidden exam may become displayed and/or a displayed exam may become hidden based on events and/or rules in the workflow.

For example, exams received from the same system are automatically linked based on set criteria. Thus, an automated behavior can be created for exams when an ordering system cannot link the exams during ordering.

In certain examples, two or more exams for the same study are linked at a modality by a technologist when performing an exam. From then on, the exams move in lock-step through the imaging workflow (not the reporting workflow). This is done by adding accession numbers (e.g., unique identifiers) for the linked exams in the single study's DICOM header. Systems capable of reading DICOM images can infer that the exams are linked from this header information, for example. However, these exams appear as separate exams in a pre-imaging workflow, such as patient wait and preparation for exams, and in post imaging workflow, such as reporting (e.g., where systems are non-DICOM compatible).

For example, using a dashboard, a CT chest, abdomen and pelvis display as three different exams. The three exams are performed together in a single scan. Since each exam is displayed independently, there is possibility of dual work (e.g., ordering additional labs if the labs are tied to the exams). Certain examples link two or more exams from the same ordering system that are normally linked and for different procedures using set of rules created by a customer such that these exams show up and progress through pre- and post-imaging workflow as linked exams. By linked exams, two or more exam records are counted as one exam since they are to be acquired/performed in the same scanning session, for example.

Exam correlation or “linking” helps reduce a potential for multiple scans when a single scan would have sufficed (e.g., images for all linked exams could have been captured in a single scan). Exam correlation/relationship helps reduce staff workload and errors in scheduling (e.g., scheduling what is a single scan across multiple days because of more than one order). Exam correlation helps reduces potential for additional radiation, additional lab work, etc. Doctors are increasingly ordering exams covering more parts of body in a single scan, especially in trauma cases, for example. Such correlation or relational linking provides a truer picture of a department workload by differentiating between scan and exam. Scan is a workflow item (not an exam), for example.

Thus, certain examples use rule-based matching of two or more exams (e.g., from the same or different ordering systems, which can be part of a rule itself) to determine whether the exams should be linked together to display as a single exam on a performance dashboard. Without such rule-based matching, a user would see two or three different exams waiting to be done for what in reality is only a single scan, for example.

Certain examples facilitate effective management of a hospital network. Certain examples provide improved awareness of day-to-day operation and action impact fallout. Certain examples assist with early detection of large-scale outliers (e.g., failures) in a hospital enterprise/workflow.

Certain examples facilitate improved hospital management at lower cost. Certain examples provide real-time and future-projected alerts. Certain examples help a user avoid complex configuration/install time. Certain examples provide auto-evolving KPI definitions without manual intervention.

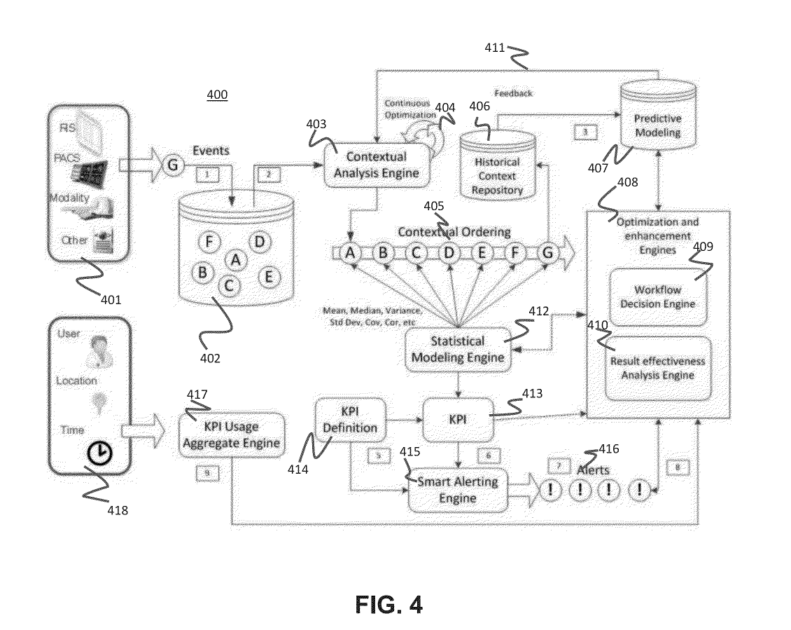

FIG. 4 illustrates an example alerting and decision-making system 400. The example system 400 provides an “intelligent” alerting and decision-making artificial intelligence engine based on dynamic contextual KPIs of continuous (or substantially continuous) future-progress data distribution statistical pattern matching. The engine includes: 1) a plug and play collection of existing healthcare departmental workflows; 2) pattern recognition of a healthcare departmental workflow based on historical and current data; 3) context extraction from data-mined information that forms a basis for contextual KPIs with healthcare-specific departmental filtering applied to provide intelligent metrics; 4) dynamic creation of contextual KPIs by joining one or more healthcare specific departmental workflow contexts; 5) autonomous and continuous (or substantially continuous) evaluation of contextual KPIs with intelligent model selection to isolate events of interest using success-driven statistical algorithm; 6) continuously (or substantially continuously) evolving monitoring based on user-evaluated success rate of identified events alerting or auto-evaluation algorithm if system is run in an autonomous mode with add-ons (e.g., expansions or additions); 7) cross-checking or validation of the information across redundant networked information sources to achieve statistically significant event identification; 8) hospital enterprise network aware feedback incorporation and tandem cross-cooperative operation; etc. The engine may operate fully autonomous or semi-autonomously, for example. While user input is not needed for functional operation, user input yields faster conversion to an improved or optimal operational point, for example.

Certain examples provide plug-and-play collection and pattern recognition of healthcare-specific departmental workflow information including historical, current, and/or projected future information. During installation, multiple triggers are instantiated to collect incoming healthcare-specific (e.g., HL7) messages.

Certain examples provide a statistical analysis and estimation engine processing sample. A statistical metric is computed based on a data distribution pattern, and then a trend is forecast by mining statistical metrics (e.g., mean, median, standard deviation, etc., using an approximation algorithm). If forecasted metric(s) fall outside of a lower specification limit (LSL) and/or an upper specification limit (USL) (e.g., a variance), the engine generates a decision matrix and sends the matrix to a user feedback engine.

As depicted in the example of FIG. 4, an analysis engine 400 receives a series of events from one or more healthcare systems 401, such as RIS, PACS, imaging modality, and/or other system. As shown at 1 in the example of FIG. 4, an event G is added to a repository 402 including events A-F. Events include factual data coming into the repository from the one or more generating entities (e.g., RIS, PACS, scanner, etc.).

At 2, one or more events are provided to a contextual analysis engine 403. The contextual analysis engine 403 processes the events to provide a contextual ordering of events 405. For example, the “pool” of events is prioritized, organized, shifted, sorted (note, not necessarily chronologically) based on one or more predicted events of interest (or groups of events) to create a contextual ordering. The order of events 405 represents a workflow of events to be executed. During ordering, for example, some events will come before other events. For example, an order comes before a completion, which comes before a signed event.

The contextual analysis engine 403 undergoes ongoing or continuous optimization or improvement 404 to improve a contextual ordering of events based on need events and new feedback received. For example, the engine 403 can provide pattern recognition based on historical and/or current data to form a contextual ordering 405.

For example, the contextual analysis engine 403 takes input from different data sources available at a healthcare facility (e.g., a hospital or other healthcare enterprise) and generates one or more KPIs based on context information. The contextual engine 403 helps to extract context from data-mined information. For example, if contextual KPIs are generated for a hospital's radiology department, the engine 403 generates a turnaround time (TAT) KPI, a count KPI, a pending exams/waiting patients KPI, etc. Based on the feedback, the engine 403 has continuous optimization capability 404 as well. Events in the context of patient wait time may be different from events in a scanned TAT. TAT is a count of exams divided into time-based categories based on turnaround time, for example. The engine 403 distinguishes this information to generate contextual KPIs.

The contextual ordering of events 405 is provided to a historical context repository 406. The historical context repository 406, at 3 in the example of FIG. 4, provides data-mined information for context extraction by a predictive modeler 407 to provide a basis for one or more contextual KPIs. In certain examples, healthcare-specific departmental filtering is applied to provide only “intelligent” metrics applicable to a particular workflow, situation, constraints, and/or environment at hand. The predictive modeler 407 processes the historical context information to provide input to one or more optimization and enhancement engines 408. The optimization and enhancement engines 408 shown in the example of FIG. 4 include a workflow decision engine 409 and a result effectiveness analysis engine 410. The predictive modeler 407 can also provide feedback 411 to the contextual analysis engine 403.

The workflow decision engine 409 uses, for example, an artificial neural network to analyze multiple data inputs from sources such as the data contextual engine 403, historical context repository 406, predictive modeler 407, statistical modeling engine 412, KPI usage pattern engine 417, etc. The workflow decision engine 409 recognizes a potential underlying workflow and uses the workflow to improve/optimize and enhance the capability of the system, for example. The workflow decision engine 409 can provide feedback back to the predictive modeler 407, for example, which in turn can provide feedback 411 to the contextual analysis engine 403, for example.

The result effectiveness analysis engine 410 uses, for example, an artificial neural network to analyze multiple data inputs from sources such as the data contextual engine 403, historical context repository 406, predictive modeler 407, statistical modeling engine 412, KPI usage pattern engine 417, etc., to provide regressive optimizing and enhancing adjustment to the capability of the system based on an effective of the result. For example, a user provided effectiveness rating for each contextual KPI and smart alert can be provided to adjust system capability/configuration. The result effectiveness analysis engine 410 can provide feedback back to the predictive modeler 407, for example, which in turn can provide feedback 411 to the contextual analysis engine 403, for example.

As shown at 4 in the example of FIG. 4, the workflow decision engine 409 uses artificial intelligence neural networks to discover patterns between the historical and predictive models of the event data that is received into the main system 400. These patterns are also based on outputs from the statistical modeling engine 412 and current KPIs 413 (including their configured threshold data), for example. The workflow decision engine 409 works to verify the predicted event data model by using the historical event data and current event data as a training set for the neural networks within the workflow decision engine 409. These results would then feed into the statistical modeling engine 412 to improve the generation of new KPIs 413 and configuration of KPI parameters. In certain examples, new KPIs may not need to be generated after the system has been running and monitoring for a period of time, but configuration of KPI parameters may be revised or updated to reflect the hospital's change in demand, throughput, etc. Through updating/revision, the KPIs can be kept relevant to the system.

As the workflow decision engine 409 and/or results effectiveness analysis engine 410 becomes more trained, the engine(s) 409/410 affects the statistical modeling engine 412 to a greater degree. The engine(s) 409/410 also send data to the statistical modeling engine 412 regarding misses in the predictive event data model and help the modeling engine 412 to remove or disable KPIs that are not deemed to be relevant.

The statistical modeling engine 412 provides a statistical modeling of received data and, as shown at 5 in the example of FIG. 4, automatically adjusts KPI parameter values or other definition 414 based on variation in the workflow parameters (e.g., interquartile range, either tighten or loosen the thresholds) based on inflight data. The statistical modeling engine 412 can compute one or more statistical metrics based on a data distribution pattern and can forecast a trend by mining statistical metrics (e.g., mean ,median, standard deviation, etc.) using an approximation algorithm, for example. One or more statistical metrics can be used to generate one or more KPIs 413 for a system based on KPI definition information 414. The KPIs 413 can be provided to the optimization and enhancement engines 408, for example. The KPI 413 can display LSL and USL (e.g., variance), for example, based on gathered statistical data. The KPI 413 and statistical modeling engine 412 can provide a data distribution pattern, which includes an extraction of interesting (e.g., non-trivial, implicit, previously unknown and potentially useful, etc.) patterns and/or knowledge from a large amount of available data (e.g., inputs from the historical context repository 406, predictive modeling 407, etc.), for example.

Thus, certain examples provide auto-generation of KPIs based at least in part on mining available data to determine meaningful metrics from the data. For example, a KPI can be generated for a radiology exam, and an algorithm mines information from the exam, and a new/updated KPI can be generated which combines the parameters. In certain examples, a combination of artificial intelligence techniques with data mining generates workflow-specific, contextual KPIs. Such KPIs can be used to analyze a system to identify bottleneck(s), inefficiency(-ies), etc. In certain examples, as the system and KPIs are used, control limits and/or other constraints are tightened based on data collected in real-time (or substantially real time accounting for system processing, access, etc., delay).

In certain examples, a particular site/environment can be benchmarked during operation of the system. Data mining of historical and current data can be used to automatically create KPIs most relevant to a particular site, situation, etc. Additionally, KPI analysis thresholds can dynamically change as a site improves from monitoring and feedback from KPIs and associated analysis. Certain examples help facilitate a metrics-driven workflow including automatic re-routing of tasks and/or data based on KPI measurement and monitoring. Certain examples not only display resulting metrics but also improve system workflow.

As shown in the example of FIG. 4, at 6, one or more KPIs 413 and KPI definitions 414 are also provided to a smart alerting engine 415 to generate, at 7, one or more alerts 416. At 8, these alert(s) 416 can be fed back to the result effectiveness engine 410 for processing and adjustment. Alert(s) 416 can be provided to other system component, user display, user message, etc., to draw user and/or automated system attention to a performance metric measurement that does not fit within specified and/or predicted bounds, for example.

For example, smart alerts 416 can include a notification generated when a patient problem is fixed and/or not fixed. Thus, a presence and/or lack of a notification with respect to patients that had and/or continue to have problems can be monitored and tracked as patients are going through a workflow to solve and/or otherwise treat a problem, for example.

In certain examples, alerts can be provided as subscription-based, for periodic, workflow-based updates for a patient. In certain examples, a family can subscribe and/or subscriptions and/or notifications can be otherwise role-based and/or relationship-based. In certain examples, notifications can be based on and/or affected by a confidential patient flag. In certain examples, dynamic alerts can be provided, and recipient(s) of those alerts can be inferred by the system and/or set by the user.

In certain examples, monitoring and evaluation continues as a system operates. As shown in the example of FIG. 4, a KPI usage aggregation engine 417 receives usage information input 418, such as user(s) of the KPIs, location(s) of use, time(s) of use, etc. The KPI usage engine 417 aggregates the usage information and, at 9, feeds the use information back to the result effectiveness analysis engine 410 and/or workflow decision engine 409 to improve workflow decisions, KPI definitions, etc., for example.

For example, a physician may use different KPIs than a nurse, or a physician may customize the same KPI using different parameters than a nurse would customize The same user may use different KPIs depending upon where the user is located at the moment. The same user may also use different KPIs depending on whether it is during the daytime or at night. This external information 418 is fed by the KPI usage engine 417 into the decision and modeling engine 409, for example.

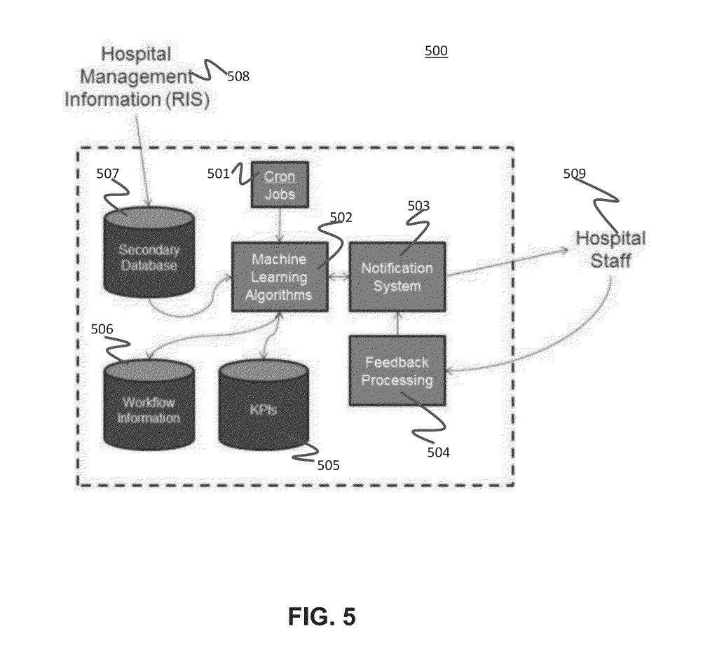

FIG. 5 illustrates an example system 500 for deployment of KPIs 505, notification 503, and feedback 504 to hospital staff and/or system(s). In the example of FIG. 5, a time-based schedule 501, such as Cron jobs, provides scheduled jobs for a workflow (e.g., a hospital workflow) to one or more machine learning algorithms and/or other artificial intelligence system 503. The machine learning algorithms process the series of jobs, tasks, or events using one or more KPIs 505, workflow information 506, secondary information 507, etc. Secondary information can include information from one or more hospital information systems (e.g., RIS, PACS, HIS, LIS, CVIS, EMR, etc.) stored in a database or other data store 507, for example. Based on the processing and analysis, the algorithms 502 generate output for a notification system 503. The notification system 503 provides alerts and/or other output to hospital staff 509 and/or other automated systems, for example. Hospital staff 509 and/or other external system can provide feedback to a feedback processor 504, which in turn can provide feedback to the notification system 503, machine learning algorithms 502, KPIs 505, workflow information 506, etc.

Certain examples dynamically alter parameters of an alert notification to respond to data coming into the system. Certain examples communicate notification(s) to one or more client terminals whether or not meta data is provided with respect to the client terminal(s). Certain examples dynamically alter the notification parameters based on the status of the database. Certain examples generate alerts dynamically in response to characteristics of the data flowing into the system.

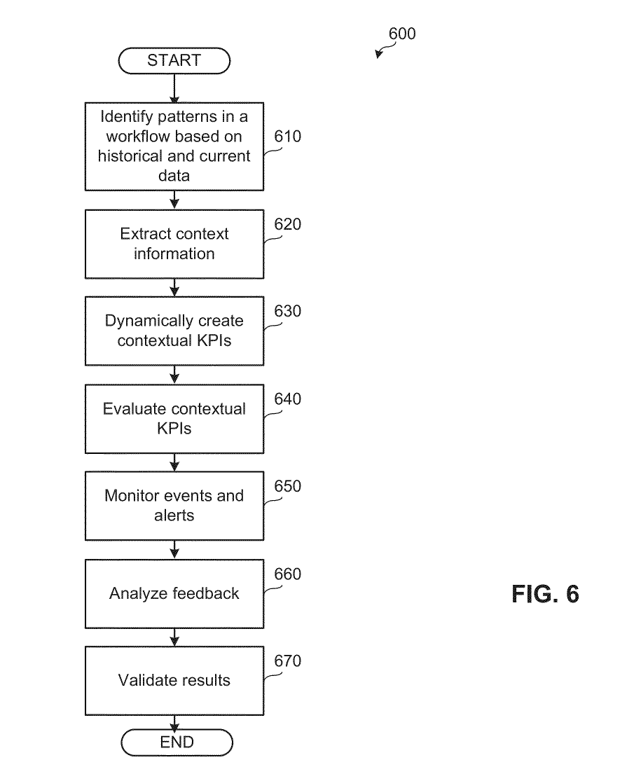

FIG. 6 illustrates an example flow diagram for a method 600 for contextual KPI creation and monitoring. At block 610, one or more patterns are identified from a healthcare departmental workflow based on historical and current data. At block 620, context information is extracted from data-mined information that forms a basis for contextual KPIs with healthcare-specific departmental filtering applied to provide intelligent metrics. At block 630, contextual KPIs are dynamically created by joining one or more healthcare specific departmental workflow contexts. At block 640, contextual KPIs are evaluated based on one or more selected models to isolate events of interest. At block 650, events and alerts are monitored. At block 660, feedback is analyzed (e.g., hospital enterprise network aware feedback incorporation and tandem cross-cooperative operation; etc.). At block 670, results are validated (e.g., by cross-checking or validation of the information across redundant networked information sources to achieve statistically significant event identification).

Thus, certain examples provide an adaptive algorithm to help provide ease of installation in different healthcare-specific workflows. Certain examples help to reduce or avoid an over-saturation of alerts due to improper user adjusted threshold(s). Certain examples leverage data collection, KPIs, and dynamic information gathering and modification to provide adaptive, reactive, and real-time information and feedback regarding a healthcare facility's system(s), workflow(s), personnel, etc.

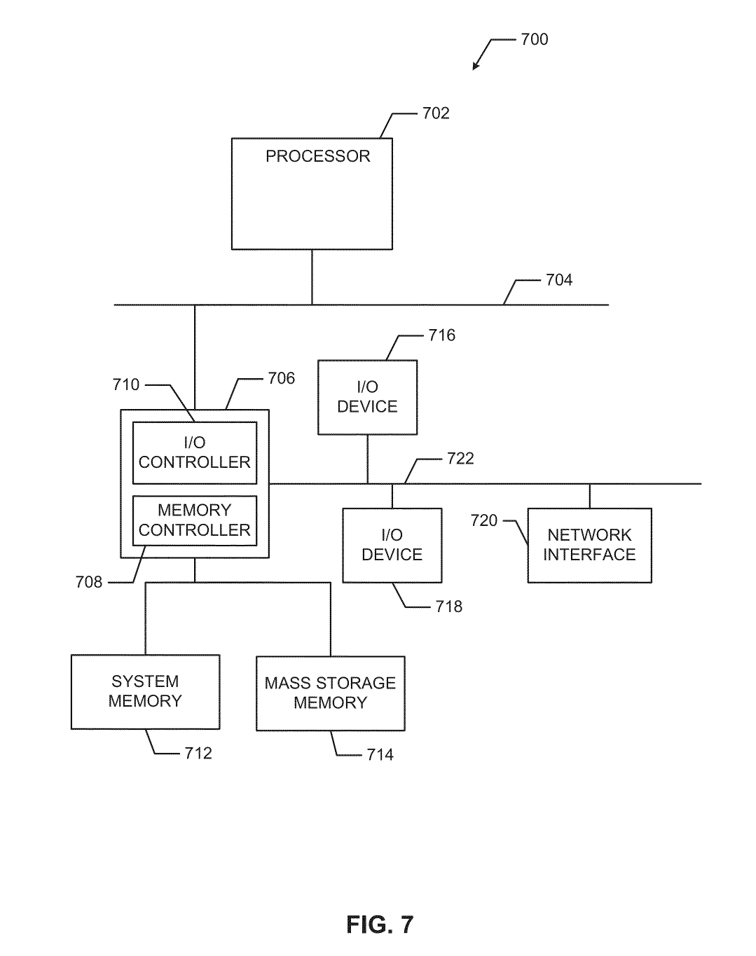

FIG. 7 is a block diagram of an example processor system 710 that may be used to implement the systems, apparatus and methods described herein. As shown in FIG. 7, the processor system 710 includes a processor 712 that is coupled to an interconnection bus 714. The processor 712 may be any suitable processor, processing unit or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate blocks within the chipset 718, the functions performed by these blocks may be integrated within a single semiconductor circuit or may be implemented using two or more separate integrated circuits.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN), a wide area network (WAN), a wireless network, a cellular phone network, etc., that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method for generating contextual performance indicators for a healthcare workflow, said method comprising:
mining a data set to identify patterns based on current and historical healthcare data for a healthcare workflow;
extracting context information from the identified patterns and data mined information;
dynamically creating contextual performance indicators based on the context and pattern information;
evaluating the contextual performance indicators based on a model;
monitoring measurements associated with the contextual performance indicators; and
processing feedback to update the context performance indicators.

2. The method of claim 1, wherein the method is to be executed autonomously and continuously with respect to a healthcare facility.

3. The method of claim 1, wherein evaluating utilizes artificial intelligence and statistical modeling to evaluate and modify contextual performance indicators.

4. The method of claim 3, further comprising automatically adjusting one or more parameters of a contextual performance indicator based on statistical modeling of data.

5. The method of claim 1, wherein processing feedback further comprises evaluating results from usage of the contextual performance indicators to adjust one or more of the contextual performance indicators.

6. The method of claim 1, further comprising aggregating usage information based on at least one of user, location, and time and providing the aggregated user information for modeling and decision adjustment.

7. The method of claim 1, further comprising generating one or more alerts based on the contextual performance indicators.

8. A tangible computer-readable storage medium having a set of instructions stored thereon which, when executed, instruct a processor to implement a method for generating operational metrics for a healthcare workflow, said method comprising:
mining a data set to identify patterns based on current and historical healthcare data for a healthcare workflow;
extracting context information from the identified patterns and data mined information;
dynamically creating contextual performance indicators based on the context and pattern information;
evaluating the contextual performance indicators based on a model;
monitoring measurements associated with the contextual performance indicators; and
processing feedback to update the context performance indicators.

9. The computer-readable medium of claim 8, wherein the method is to be executed autonomously and continuously with respect to a healthcare facility.

10. The computer-readable medium of claim 8, wherein evaluating utilizes artificial intelligence and statistical modeling to evaluate and modify contextual performance indicators.

11. The computer-readable medium of claim 10, further comprising automatically adjusting one or more parameters of a contextual performance indicator based on statistical modeling of data.

12. The computer-readable medium of claim 8, wherein processing feedback further comprises evaluating results from usage of the contextual performance indicators to adjust one or more of the contextual performance indicators.

13. The computer-readable medium of claim 8, further comprising aggregating usage information based on at least one of user, location, and time and providing the aggregated user information for modeling and decision adjustment.

14. The computer-readable medium of claim 8, further comprising generating one or more alerts based on the contextual performance indicators.

15. A healthcare workflow performance monitoring system comprising:
a contextual analysis engine to mine a data set to identify patterns based on current and historical healthcare data for a healthcare workflow and extract context information from the identified patterns and data mined information;
a statistical modeling engine to dynamically create contextual performance indicators based on the context and pattern information including a contextual ordering of events in the healthcare workflow;
a workflow decision engine to evaluate the contextual performance indicators based on a model and monitor measurements associated with the contextual performance indicators, the workflow decision engine to process feedback to update the context performance indicators.

16. The system of claim 15, wherein the workflow decision engine is to work with a result effectiveness analysis engine to monitor measurements and process feedback.

17. The system of claim 15, wherein the contextual analysis engine is to receive predictive modeling feedback for further refinement of contextual analysis.

18. The system of claim 15, wherein the workflow decision engine is to utilize artificial intelligence and statistical modeling to evaluate and modify contextual performance indicators.

19. The system of claim 18, wherein the workflow decision engine and the statistical modeling engine are to automatically adjust one or more parameters of a contextual performance indicator based on statistical modeling of data.

20. The system of claim 15, further comprising a usage aggregation engine to aggregate usage information based on at least one of user, location, and time and provide the aggregated user information for modeling and decision adjustment of contextual performance indicators.

21. The system of claim 15, further comprising an alerting engine to generate one or more alerts based on the contextual performance indicators.
